(19) United States
(12) Patent Application Publication
(10) Pub. No.: US 2012/0054382 A1
(43) Pub. Date: Mar. 1, 2012

(54) METHOD OF HAND-HELD SMART DEVICE FOR ACCESSING DATA

(75) Inventor: Gary Kung, Santa Ana, CA (US)

(73) Assignee: I/O INTERCONNECT, LTD., Santa Ana, CA (US)

(21) Appl. No.: 13/218,994

(22) Filed: Aug. 26, 2011

Related U.S. Application Data
(60) Provisional application No. 61/378,443, filed on Aug. 31, 2010.

(51) Int. Cl. G06F 13/14

(52) U.S. Cl. 710/33

(57) ABSTRACT

A method for accessing data provided by the present invention is suitable for a hand-held smart device which has an internal storage unit. The method would establish a data access path between the hand-held smart device and an external storage device, when the external storage device connects to the hand-held smart device through a connection interface. Then, the method copies the data saved in the internal storage unit to the external storage device. Furthermore, the method defines the external storage device as a master storage terminal, and makes the hand-held smart device accessing data with the external storage device directly.

### CROSS-REFERENCE TO RELATED APPLICATIONS

The application claims priority of US provisional patent application Ser. No. 61/378,443 filed on Aug. 31, 2010, the contents of which are hereby incorporated by reference.

### FIELD OF THE INVENTION

The present invention relates to a data accessing technology, and more particularly to dynamic adjust data storing capacitance for accessing data.

### BACKGROUND OF THE INVENTION

Nowadays, the functions of a portable device such as a smart phone and a tablet can be equal to the functions of a traditional notebook computer. In addition, the portable device is designed trending to be light and thin, thus, the portable device is much more convenient than the notebook computer. Further, starting and operation of the portable device is much easier than the notebook computer. To be obvious, the portable device will become main-stream of the market in the near or foreseeable future.

Through the portable device gradually replaces currently popular notebook computer to be a technology device carried with a user. However, due to the light and thin design trend, some of the original functions of the notebook computer must be selected and abandoned, such as capacity of an internal hard-disk.

With light and thin structure, the portable device can not carry a HDD originally used for the notebook. A lighter and thinner solid state disk or an extractable disk can be used for providing a storage space. The capacity of the solid state disk or extractable disk has been improved with developing technology, but still is less than the capacity of the conventional hard-disk. Therefore, the user can not store or setup a mass of data or processes, and must make a selection and abandon about the storage data. In addition, under the design limitation, the portable device does not have a universal serial bus (USB) as the common notebook computer. Thus, it's also inconvenient for the user that some data in the portable device must be copied through an original connecting wire being connected to a computer.

### SUMMARY OF THE INVENTION

Therefore, the present invention is to provide a method for accessing data, being able to improve the data store capacitance in a hand-held smart device.

A method for accessing data provided by the present invention is suitable for a hand-held smart device which has an internal storage unit. The method would establish a data access path between the hand-held smart device and an external storage device, when the external storage device connects to the hand-held smart device through a connection interface. Then, the method copies the data saved in the internal storage unit to the external storage device. Furthermore, the method defines the external storage device as a master storage terminal, and makes the hand-held smart device accessing data with the external storage device directly.

In one embodiment of the present invention, the method further determines whether or not an extension storage capacitance operation is executed. When the extension storage capacitance operation is executed, the method performs the step of establishing the data access path.

Since the present invention establishes the data access link between the hand-held smart device and the external storage device as the external storage connecting with the hand-held smart device, the data store capacitance is extended. Therefore, the user can operate the hand-held smart device to save mass data.

### BRIEF DESCRIPTION OF THE DRAWINGS

The above objects and advantages of the present invention will become more readily apparent to those ordinarily skilled in the art after reviewing the following detailed description and accompanying drawings, in which:

FIG. 1 is a block diagram of a hand-held smart device according to one preferred embodiment of the present invention.

FIG. 2 is a block diagram of an external storage device according to one preferred embodiment of the present invention.

FIG. 3 is a flow chart of a method for accessing data according to one preferred embodiment of the present invention.

### DETAILED DESCRIPTION OF PREFERRED EMBODIMENTS

The present invention will now be described more specifically with reference to the following embodiments. It is to be noted that the following descriptions of preferred embodiments of this invention are presented herein for purpose of illustration and description only. It is not intended to be exhaustive or to be limited to the precise form disclosed.

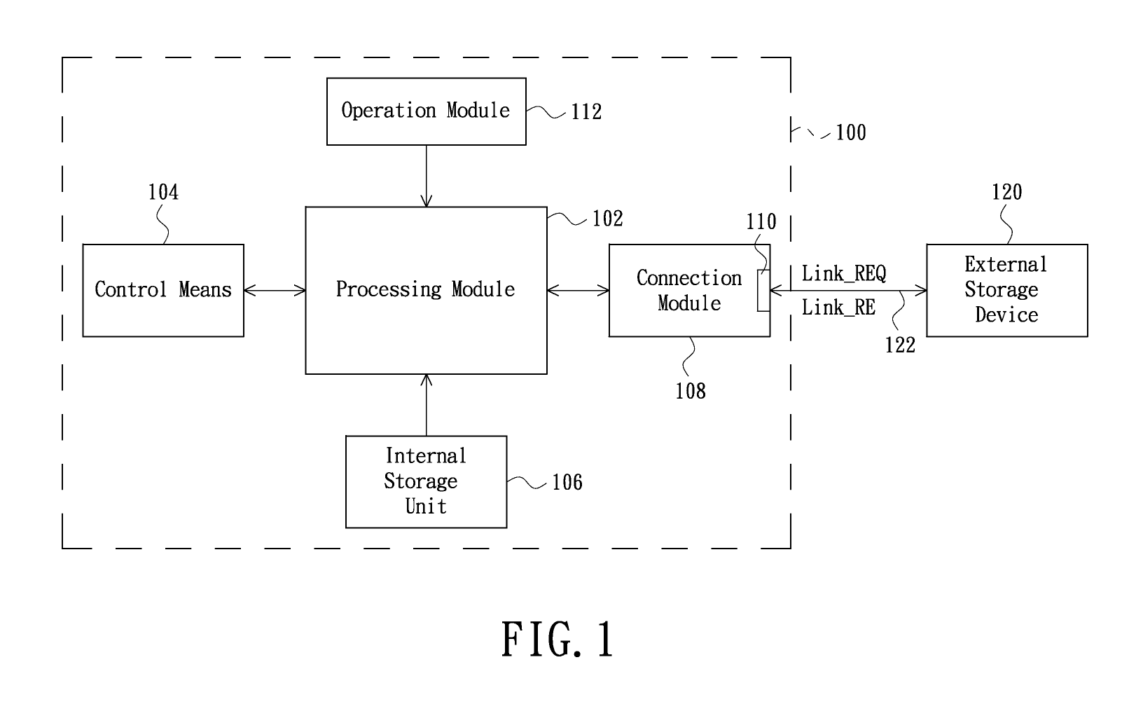

FIG. 1 is a block diagram of a hand-held smart device according to one preferred embodiment of the present invention. Referring to the FIG. 1, the hand-held smart device 100 of the embodiment is probably a smart phone, a pocket computer, a tablet computer, a camera, a multi-media player, etc. In some exemplary embodiments, the hand-held smart device 100 comprises a processing module 102, a control means 104, an internal storage unit 106 and a connection module 108. The processing module 102 couples to the internal storage unit 106 and the connection module 108, and communicates with the control means 104.

In some embodiments, the control means 104 is implemented by an application program, and installed into the internal storage unit 106. Additionally, the internal storage unit 106 is probably a hard-disk, or a solid hard-disk, such like a flash memory. In a normal operation of the hand-held smart device 100 of the exemplary embodiment, the processing module 102 is to access data with the internal storage unit 106. In addition, the connection module 108 has an I/O port 110. In some embodiments, the I/O port has a special specification.

In some embodiments, the hand-held smart device 100 further has a operation module 112 coupled to the processing module 102. the operation module 112 has at least one operation unit, such like real key, touch control unit, joystick, wheel, etc. In other embodiments, the operation module 112 comprises a hot key. When the hot key is pressed or enabled by other means, the control means 104 is started.

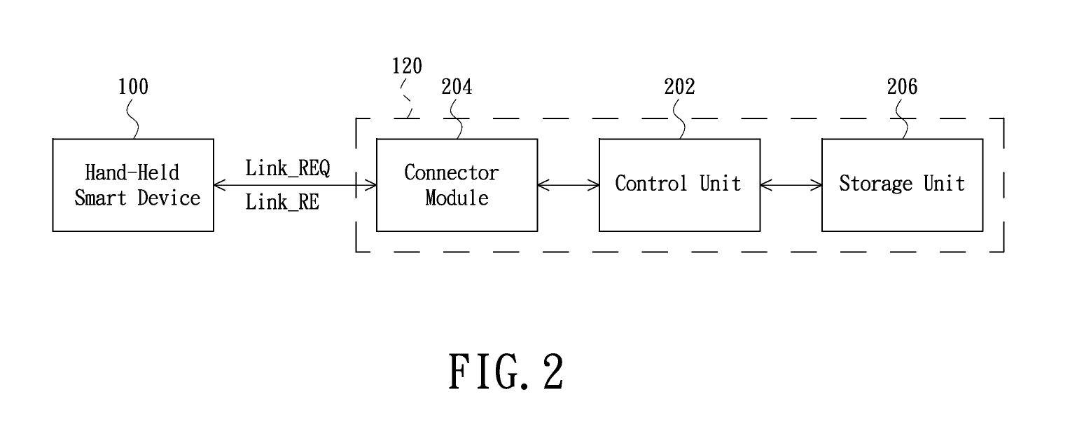

Meanwhile, when an external storage device 120 connects to the connection module 108, the processing module 102 would notify the control means 104. In some embodiments, the external storage device is an external hard-disk. FIG. 2 is a block diagram of an external storage device according to one preferred embodiment of the present invention. The external storage device 120 probably has a control unit 202, a connector module 204, and a storage unit 206. Wherein the control unit 202 is coupled to the connector module 204 and the storage unit 206. In the exemplary embodiment, the storage unit 206 is probably a flash memory.

Referring to the FIGS. 1 and 2, in some embodiments, the connector module 204 can connects to the connection module 108 through a transfer line 122. When the control means 104 determines the external storage device 120 connects to the connection module 108, the control means 104 would a link between the hand-held smart device 100 and the external storage device 120. In some embodiments, the control means 104 would send a link request Link_REQ to the external storage device 120. Meanwhile, the control unit 202 would receive the link request Link_REQ for performing a hand-shake operation. If the control unit determines generating a link response information Link_RE for responding the link request Link_REQ, the link between the hand-held smart device 100 and the external storage device 120 would be established.

When the link between the hand-held smart device 100 and the external storage device 120 is established, the control means 104 sets the internal storage unit 106 as a master storage terminal and sets the external storage device 120 as a slave storage terminal. Therefore, the control mans 104 can perform a backup operation to backup the data saved in the internal storage unit 106 to the external storage device 120.

If the backup operation is failed, such like the external storage device being broke off from the hand-held smart device during the period of performing the operation, the control means 104 would generate an alarm to notify user to ask the user updating the backup operation or abandoning the backup operation.

On the contrary, if the backup operation is completed, the control means 104 would switch the external storage device 120 as the master storage terminal from the slave storage terminal, and switch the internal storage unit 106 as the slave storage terminal from the master storage terminal or hide the internal storage unit 106 for establishing a data access path between the apparatus 100 and the external storage device 120. Therefore, the processing module 102 can access data with the external storage device 120 directly. Meanwhile, the processing module 102 would not access data with the internal storage unit 106 actively.

At this time, if the user sends a disconnect request to the control means 104, the control means 104 could choose copying the data saved in the external storage device 120 back to the internal storage unit 106 or not for executing a recovery procedure to respond the disconnect request. When the recovery procedure is completed, the control means 104 permits the user disconnecting the external storage device 120 from the hand-held smart device 100.

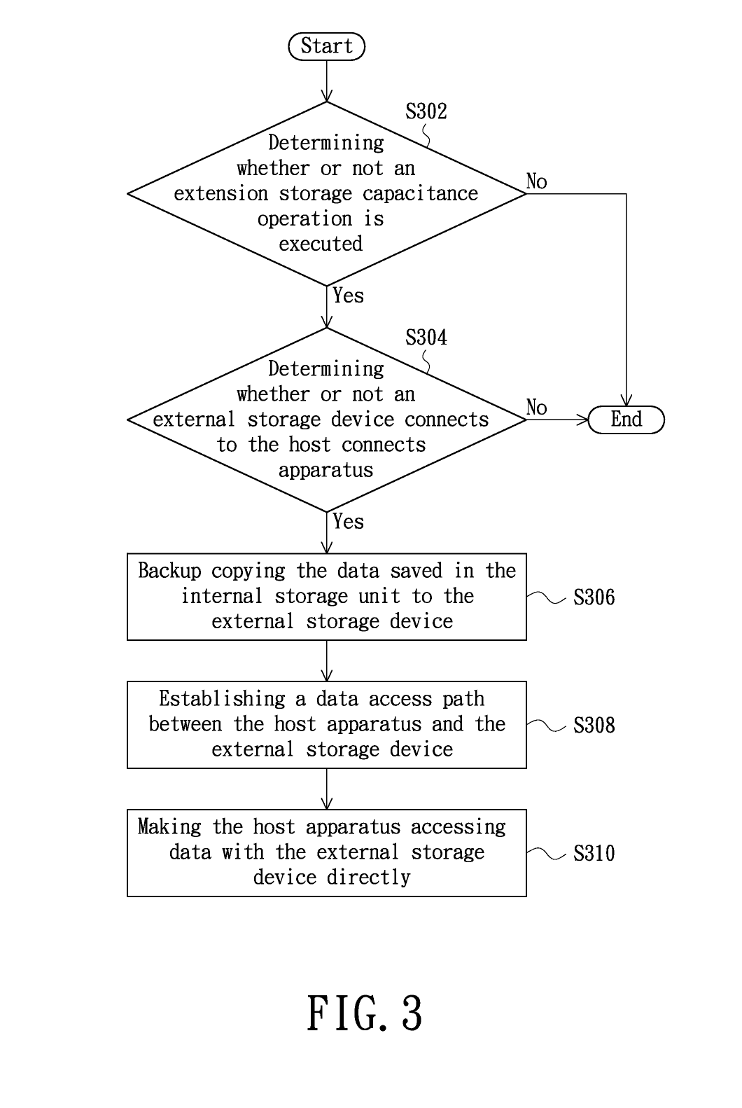

FIG. 3 is a flow chart of a method for accessing data according to one preferred embodiment of the present invention. Referring to the FIG. 3, the method of the embodiment is suitable for a hand-held smart device which has an internal storage unit. The method, first, determines whether or not an extension storage capacitance operation is executed, as description in the step S302. If the extension storage capacitance operation is executed (i.e., the “Yes” labeled on the step S302), the method carries out the step S304 to determine whether or not an external storage device connects to the hand-held smart device.

If the external storage device is connected to the hand-held smart device (i.e., the “Yes” labeled on the step S304), the method would backup the data saved in the internal storage unit to the external storage device, as description in the step S306. Then, the step 306 is performed to establish a data access path between the hand-held smart device and the external storage device. Therefore, the method, as description in the step S310, would make the hand-held smart device accessing data with the external storage device directly.

In summary, the present invention can make the hand-held smart device accessing data with the external storage device directly, the storage capacitance of the hand-held smart device is improved without changing the hardware structure of the hand-held smart device.

While the invention has been described in terms of what is presently considered to be the most practical and preferred embodiments, it is to be understood that the invention needs not be limited to the disclosed embodiment. On the contrary, it is intended to cover various modifications and similar arrangements included within the spirit and scope of the appended claims which are to be accorded with the broadest interpretation so as to encompass all such modifications and similar structures.

What is claimed is:

1. A method of a hand-held smart device for accessing data, comprising:
establishing a data access path with an external storage device connecting with the hand-held smart device;
copying the data saved in an internal storage unit of the hand held smart device to the external storage device; and
defining the external storage device as a master storage terminal, and making the hand-held smart device accessing data with the external storage device directly.

2. The method according to claim 1, further comprising:
defining the internal storage unit as a slave storage terminal;

3. The method according to claim 1, further comprising:
hiding the internal storage unit from the hand-held smart device

4. The method according to claim 1, further comprising:
determining whether or not an extension storage capacitance operation is executed; and
performing the step of establishing the data access path, when the extension storage capacitance operation is executed.

5. The method according to claim 1, further comprising:
copying the data saved in the external storage device to the internal storage unit for responding a disconnecting request, so as to permit the external storage device disconnecting from the hand-held smart device.

6. The method according to claim 1, further comprising:
generating an alarm message, when the external storage device disconnects from the hand-held smart device during the period of performing the backup operation.

7. The method according to claim 6, further comprising:
copying the data saved in the external storage device to the internal storage unit for responding a disconnecting request, so as to permit the external storage device disconnecting from the hand-held smart device.
